(19) United States
(12) Patent Application Publication
(10) Pub. No.: US 2026/0301467 A1
(43) Pub. Date: Oct. 1, 2026

(54) EMOTION AND ACTION RECOGNITION AI

(71) Applicants: Muhammad Waqas, Karachi (PK); Muhammad Usman, Karachi (PK)

(72) Inventors: Muhammad Waqas, Karachi (PK); Muhammad Usman, Karachi (PK)

(21) Appl. No.: 19/094,681

(22) Filed: Mar. 28, 2025

(51) Int. Cl. G06V 40/20; A63F 13/67; G06V 10/62; G06V 10/72; G06V 10/764; G06V 10/82; G06V 20/40; G06V 40/16

(52) U.S. Cl. CPC G06V 40/23; A63F 13/67; G06V 10/62; G06V 10/72; G06V 10/764; G06V 10/82; G06V 20/40; G06V 40/174

(57) ABSTRACT

In one aspect, a method for emotion and action recognition, comprising: receiving, at one or more processors, image data from a video stream; analyzing, using a convolutional neural network, the image data to identify facial expressions for emotion recognition; extracting, using a landmark detection model, a plurality of body landmarks from the image data; determining, based on the plurality of body landmarks, spatial relationships between body joints over a sequence of frames; classifying, using a long short-term memory (LSTM) network, an action based on changes in the spatial relationships across the sequence of frames; and outputting both an emotional state classification and an action classification based on the analyzing and the classifying.

### BACKGROUND OF THE INVENTION

Computer vision systems have traditionally struggled with the complex task of simultaneously recognizing both human emotions and actions in real-time video streams. While separate solutions exist for facial expression analysis and pose estimation, the integration of these capabilities into a unified, efficient system remains challenging. This technical limitation has implications across multiple industries, from human-computer interaction to security and gaming applications.

Existing emotion recognition systems often rely heavily on high-resolution facial images and controlled lighting conditions, making them impractical for real-world applications where environmental conditions vary significantly. These systems frequently fail to maintain accuracy when processing video streams in dynamic environments, particularly when subjects are moving or partially occluded. Additionally, current solutions typically require substantial computational resources, limiting their deployment on edge devices and in real-time applications.

Action recognition systems face similar technical hurdles. Traditional approaches often require multiple cameras or specialized sensors to accurately track human movement, adding complexity and cost to implementations. Many existing solutions struggle with the temporal aspect of action recognition, failing to effectively analyze movement sequences across multiple frames. This limitation makes it difficult to distinguish between similar actions or to detect subtle variations in movement patterns.

Furthermore, current systems typically process emotion and action recognition as entirely separate tasks, using independent models and processing pipelines. This separation creates technical inefficiencies, increases computational overhead, and fails to leverage potential synergies between emotional and physical state analysis. The lack of integration also results in increased latency and resource utilization, making it challenging to deploy these systems in applications requiring real-time response.

Previous attempts to combine emotion and action recognition have often resulted in systems that are either too computationally intensive for real-time processing or too simplified to provide accurate results. These systems frequently struggle with the challenge of maintaining accuracy while processing multiple data streams simultaneously, particularly when operating under resource constraints.

The limitations of existing systems are particularly evident in applications requiring real-time analysis of both emotional states and physical actions, such as interactive gaming, security monitoring, or healthcare assessment. These applications demand solutions that can process multiple modes of human behavior simultaneously while maintaining high accuracy and low latency.

Furthermore, computer vision systems have traditionally struggled with the complex task of simultaneously recognizing both human emotions and actions in real-time video streams. While separate solutions exist for facial expression analysis and pose estimation, the integration of these capabilities into a unified, efficient system remains challenging. This technical limitation has implications across multiple industries, from human-computer interaction to security and gaming applications.

Existing emotion recognition systems often rely on high-resolution facial images and controlled lighting, making them less effective in dynamic, real-world conditions. They tend to struggle in environments with variable lighting, motion blur, and partial occlusions. Action recognition systems face similar hurdles, especially when temporal analysis across multiple frames is required to distinguish subtle movements or complex sequences. Combined emotion and action recognition systems must process multiple data streams simultaneously, further increasing complexity and computational resource demands. These limitations often make real-time processing on edge devices particularly challenging.

Moreover, many current systems fail to leverage potential synergies between emotional state recognition and action classification, leading to inefficiencies in performance and increased latency. Systems that attempt to combine these features often compromise on accuracy or require significant computational power.

### SUMMARY OF THE INVENTION

In one aspect, A method for emotion and action recognition, comprising: receiving, at one or more processors, image data from a video stream; analyzing, using a convolutional neural network, the image data to identify facial expressions for emotion recognition; extracting, using a landmark detection model, a plurality of body landmarks from the image data; determining, based on the plurality of body landmarks, spatial relationships between body joints over a sequence of frames; classifying, using a long short-term memory (LSTM) network, an action based on changes in the spatial relationships across the sequence of frames; and outputting both an emotional state classification and an action classification based on the analyzing and the classifying.

In another aspect, a system for emotion and action recognition, comprising: one or more processors; a memory coupled to the one or more processors; an image capture device configured to provide image data; a convolutional neural network implemented by the one or more processors and configured to analyze facial expressions in the image data; a landmark detection model implemented by the one or more processors and configured to extract body landmarks from the image data; a long short-term memory (LSTM) network implemented by the one or more processors and configured to classify actions based on the body landmarks; and wherein the one or more processors are configured to output both emotional state classifications and action classifications based on the analyzed facial expressions and classified actions.

An emotion and action recognition system comprising: a computer vision module configured to receive image data from video streams; a neural network configured to identify facial expressions from the received image data; a landmark detection model configured to extract body landmarks for action classification from the received image data; a memory storing instructions; and a processor configured to execute the instructions to: capture video frames from at least one of a camera or a video file, convert each frame into a binary input array, apply deep learning techniques to estimate poses and classify emotions into at least five emotional states, process a sequence of frames using a recurrent neural network to output classified actions based on changes in spatial relationships, store results of pose estimations as global variables in the memory, access the stored results using application programming interfaces for further processing, and implement optimization techniques including at least batch normalization and data augmentation during preprocessing to improve accuracy and reduce latency.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for emotion and action recognition AI, according to some embodiments.

FIG. 2 illustrates an example data preparation process for emotion recognition, according to some embodiments.

FIG. 3 illustrates an example Model Architecture, according to some embodiments.

FIG. 4 illustrates an example set of functions for each convolution block usable by a model architecture, according to some embodiments.

FIGS. 5-10 illustrate example schematics for model diagrams implementing steps 102, according to some embodiments.

FIG. 11 illustrates an example process for data preparation and processing for AI Action recognition, according to some embodiments.

FIG. 12 illustrates an example process for Data Processing for Action Recognition, according to some embodiments.

FIG. 13 illustrates an example AI action recognition model, according to some embodiments.

FIG. 14 illustrates an example architecture of an example LSTM Cell, according to some embodiments.

FIG. 15-17 illustrate example model development and/or management operations, according to some embodiments.

FIG. 18 illustrates an example process, according to some embodiments.

FIG. 19 illustrates an example logic, according to some embodiments.

FIG. 20 illustrates an example process of a full action recognition pipeline for approach 2, according to some embodiments.

FIG. 21 illustrates an example process for implementing an SDK, according to some embodiments.

FIG. 22 can be used for emotion recognition, according to some embodiments.

FIG. 23 can be used for Action Recognition Approach 1, according to some embodiments.

FIG. 24 can be used for Action Recognition Approach 2, according to some embodiments.

FIG. 25 depicts an exemplary computing system that can be configured to perform any one of the processes provided herein.

FIG. 26 illustrates an example Emotion and Action Recognition AI System, according to some embodiments.

FIG. 27 illustrates an example process for emotion and action recognition with AI, according to some embodiments.

FIG. 28 illustrates an example process for implementing a WebGL Deployment Process Flow for Emotion and Action Recognition SDK, according to some embodiments.

FIG. 29 illustrates an example visualization of an integration process, according to some embodiments.

The Figures described above are a representative set and are not an exhaustive set with respect to embodying the invention.

### DESCRIPTION

Disclosed are a system, method, and article of manufacture of an emotion and action recognition AI. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Application programming interface (API) can specify how software components of various systems interact with each other.

Artificial neural networks (ANNs, “neural networks”) are computing systems inspired by the biological neural networks that constitute animal brains. An ANN is based on a collection of connected units or nodes called artificial neurons. Each connection, like the synapses in a biological brain, can transmit a signal to other neurons. An artificial neuron receives signals then processes them and can signal neurons connected to it. The “signal” at a connection is a real number, and the output of each neuron may be computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold.

Binary classification is the task of classifying the elements of a set into two groups (e.g. each called class) on the basis of a classification rule. Statistical classification is a problem studied in machine learning. It is a type of supervised learning, a method of machine learning where the categories are predefined and is used to categorize new probabilistic observations into said categories. When there are only two categories the problem is known as statistical binary classification. Some of the methods commonly used for binary classification are, inter alia: Decision trees, Random forests, Bayesian networks, Support vector machines, Neural networks, Logistic regression, Probit model, Genetic Programming, Multi expression programming, Linear genetic programming, etc.

ck+ 48 dataset with top five (5) emotions.

Deep learning is a family of machine learning methods based on learning data representations. Learning can be supervised, semi-supervised or unsupervised.

FER2013 is a data set of images used to have models learn facial expressions from an image. The data consists of 48×48 pixel grayscale images of faces. The faces have been automatically registered so that the face is more or less centered and occupies about the same amount of space in each image. The task is to categorize each face based on the emotion shown in the facial expression into one of seven categories (0=Angry, 1=Disgust, 2=Fear, 3=Happy, 4=Sad, 5=Surprise, 6=Neutral). The training set consists of 28,709 examples and the public test set consists of 3,589 examples. Other similar data sets can be used as well.

Keras is an open-source software library that provides a Python interface for artificial neural networks. Keras acts as an interface for the TensorFlow library. Other embodiments may be used in other examples.

Long short-term memory (LSTM) is an artificial neural network used in the fields of artificial intelligence and deep learning. Unlike standard feedforward neural networks, LSTM has feedback connections. Such a recurrent neural network (RNN) can process not only single data points (e.g. digital images), but also entire sequences of data (e.g. video). LSTM networks can be used for processing and predicting data.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Maxpooling can be a sample-based discretization process. Maxpooling can be used to down-sample an input representation (e.g. image, hidden-layer output matrix, etc.). In this way, the dimensionality can be reduced. Various assumptions can then be made about features contained in various binned sub-regions.

Multiclass classification or multinomial classification is the problem of classifying instances into one of three or more classes (e.g. classifying instances into one of two classes is called binary classification). While many classification algorithms (e.g. notably multinomial logistic regression) naturally permit the use of more than two classes, some are by nature binary algorithms; these can, however, be turned into multinomial classifiers by a variety of strategies. existing multi-class classification techniques can be categorized into, inter alia: transformation to binary, extension from binary, hierarchical classification.

Recurrent neural network (RNN) is a class of artificial neural networks where connections between nodes can create a cycle, allowing output from some nodes to affect subsequent input to the same nodes.

Regularization is a technique used to reduce errors by fitting the function appropriately on the given training set and avoiding overfitting (e.g. Lasso Regularization, Ridge Regularization; Elastic Net Regularization; etc.).

Sigmoid function is an activation function normally used in the final layer of binary classifier. A Sigmoid function gives output between 0-1 as the probability of an instance belonging to a positive class.

SoftMax function can convert a vector of K real numbers into a probability distribution of K possible outcomes. SoftMax function can be a generalization of the logistic function to multiple dimensions and used in multinomial logistic regression. The SoftMax function can be used as the last activation function of a neural network to normalize the output of a network to a probability distribution over predicted output classes, based on Luce's choice axiom.

Software development kit (SDK) is a collection of software development tools in one installable package. An SDK can facilitate the creation of applications by having a compiler, debugger and sometimes a software framework. SDK can be a collection of software tools, libraries, and documentation that enables developers to create applications for specific platforms or frameworks. In the context of the emotion and action recognition system, the SDK processes image data using neural networks to identify facial expressions and extract body landmarks for action classification. It provides developers with pre-built components for capturing video frames, converting them to binary input arrays, and applying deep learning techniques to estimate poses and classify emotions across five states: angry, happy, sad, neutral, and surprise. The SDK employs optimization techniques like batch normalization, data augmentation, and multi-threaded processing to ensure efficient real-time performance across different deployment environments.

TensorFlow is a free and open-source software library for machine learning and artificial intelligence. TensorFlow can be used across a range of tasks but has a particular focus on training and inference of deep neural networks.

Transpiler is a type of compiler that converts source code written in one programming language into equivalent source code in another programming language of similar abstraction level, unlike traditional compilers that translate to lower-level code. Transpilers perform source-to-source transformation by parsing the input code into an abstract syntax tree (AST), applying language-specific transformations, and then generating target language code that preserves the original program's semantics and structure. Transpilers often include sophisticated type checking, polyfilling capabilities, and code optimization techniques to ensure the generated code maintains compatibility with the target environment while leveraging native features when available.

### Example Methods and Systems

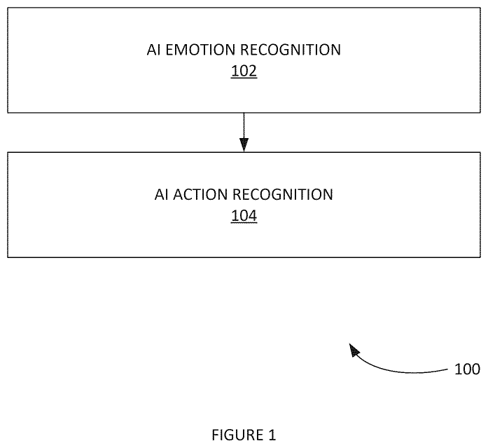

FIG. 1 illustrates an example process 100 for emotion and action recognition AI, according to some embodiments. Process 100 can implement AI emotion recognition in step 102. Process 100 can implement AI action recognition in step 104.

Step 102 is now discussed in further detail.

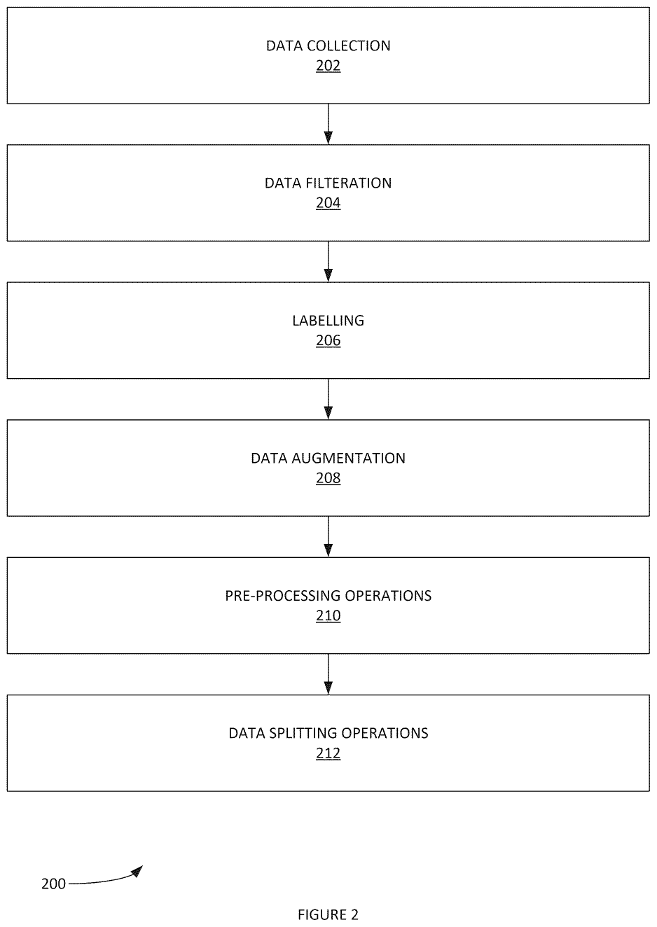

FIG. 2 illustrates an example data preparation process for emotion recognition, according to some embodiments. This can be used to implement part of step 102. In step 202, process 200 can be performed data collection. Process 200 can perform data filtration in step 204. Process 200 can perform preparation for data labeling in step 206. Process 200 can perform data augmentation in step 208. Process 200 can perform pre-processing operations 210. Process 200 can perform data splitting operations in step 212.

In an example data collection step, for training and evaluation of an Emotion Recognition Model, process 200 can use the following publicly available datasets, inter alia: FER 2013. This dataset has 7 emotions out of which we used only 5 (‘angry’, ‘happy’, ‘sad’, ‘neutral’ and ‘surprise’) and excluded (‘fear’ and ‘disgust’) as per present embodiment needs. Process 200 can use the CK+ 48 data set. This data set is available on Kaggle. This dataset also has 7 emotions. Process 200 can exclude unneeded emotions (e.g. “contempt,” “fear” and “disgust”). Process 200 can use the driver drowsiness dataset. This data set is developed and made publicly available by DataFlair (e.g. Software Training Institute in Indore, India). This dataset can be used for “open mouth” images from this dataset to add noise to the dataset. Process 200 can also use various relevant images obtained from digital image search engines. Some.

Data filtration can include manually and/or automatically filtering out the dataset to remove intra class variance. Data augmentation can be used to augment the dataset using different brightness levels in images to counter light consistency issues and to increase the size of the dataset to avoid underfitting. To change the brightness levels of images, process 200 can used “Pillow” (python library for image processing). The ImageDataGenerator from Keras API (Python library for Neural Networks) is then used to further augment data by rotating, shifting, flipping, shearing, and zooming in images.

Pre-processing Images can be already resized to (48*48) and converted to grayscale in the dataset. Rescaled pixel intensities to range (0-1) in the first layer of the model.

Data Splitting can be performed on the images. For example, the image can then be split into training and validation sets with 80:20 ratio respectively.

An Emotion Recognition Model can be trained for both Binary and Multiclass Classifications. Implement separate Binary Classifier for 4 emotions, ‘Angry’, ‘Happy’, ‘Sad’ and “Surprise” by putting one emotion in the “positive” class and the remaining emotions in the “Negative” class.

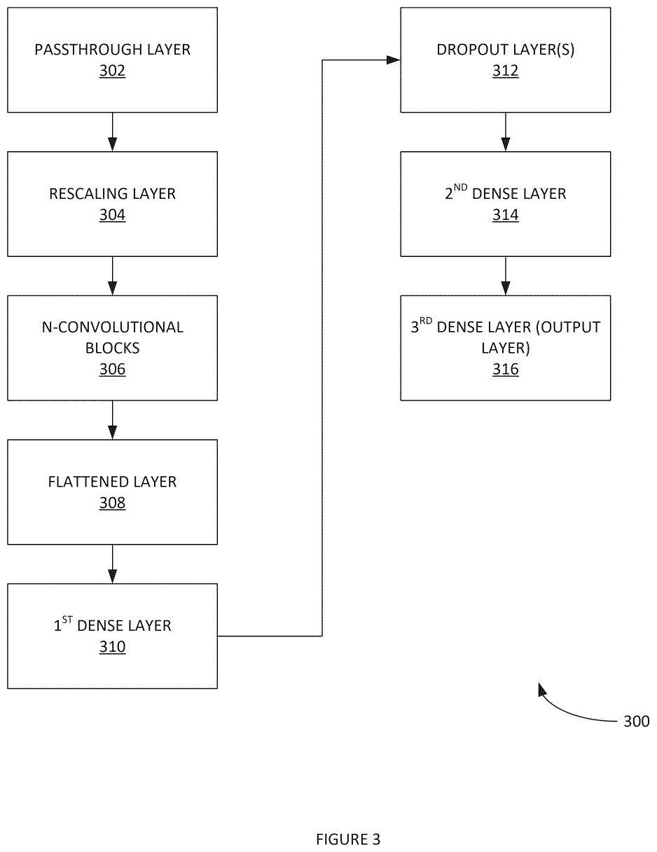

FIG. 3 illustrates an example Model Architecture 300, according to some embodiments.

Model Architecture 300 can be a model built for Emotion Recognition. In one example, the model has 30 layers in total. The first layer can be a rescaling layer. The rescaling layer can be used in the Action Recognition Model. The shape of the input image can be defined. The rescaling layer rescales the input to the range (0-1) by dividing the pixel intensities of the images by 255. The images are rescaled to this range to avoid vanishing gradients problem. Then there are 4 Convolutional Blocks. Architecture of the block is:
1) 2-dimensional convolutional layer;
2) Batch Normalization Layer;
3) 2-dimensional convolutional layer;
4) Batch Normalization Layer;
5) 2-dimensional Max Pooling layer; and
6) Dropout Layer.

Model Architecture 300 then has layer which reshapes the outputs from the last convolutional block to make it compatible with the next layer's input shape. Then there can be 3 dense layers (e.g. fully connected layers with one more dropout layer between the first and second dense layers. The last dense layer is the output layer, which contains one neuron and sigmoid activation for Binary classification and five neurons and ‘SoftMax’ activation for Multiclass classification.

In one example, Model Architecture 300 can include passthrough layer 302. Model Architecture 300 can include rescaling layer 304 that then outputs to n-convolutional blocks 306. The output is the provided to flattened layer 308. Model Architecture 300 can include a 1^{st} dense layer 310 and a dropout layer 312. Model Architecture 300 can include a 2^{nd} dense layer 314 and 3^{rd} dense layer (e.g. output layer) 316.

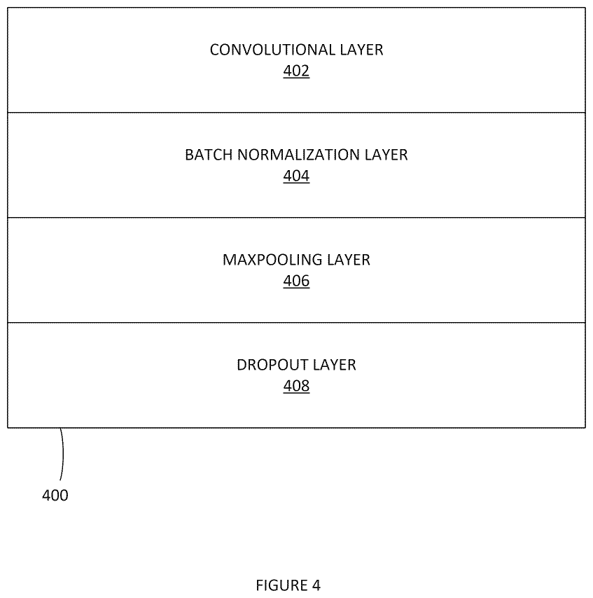

FIG. 4 illustrates an example set of functions 400 for each convolution block usable by model architecture 300, according to some embodiments.

The layers can include a Convolutional Layer. This layer slides a kernel along both dimensions to extract features from the Input image, computing a convolution matrix which contains weights for neurons and outputs feature maps.

The layers can include a Batch Normalization Layer. This layer standardizes the inputs, so it acts as a regularizer and keeps the Model from overfitting the training set. It computes the mean and standard Deviation of the input image. Standardizes the image and then Rescales and Shifts the image.

The layers can include a MaxPooling Layer that reduces the size of the input image to lighten the model, to regularize it, and to introduce translational and rotational invariances. The layers can include a Dropout Layer Regularization layer to keep the model from overfitting.

In one example, the layered set of function 400 can include a convolutional layer 402, a batch normalization layer 404, a MaxPooling layer 406, and/or a dropout layer 408.

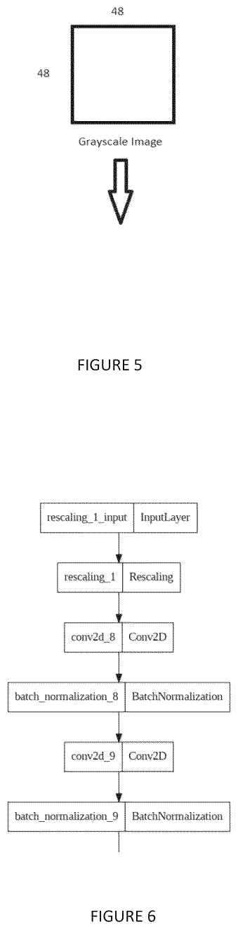

FIGS. 5-10 illustrate example schematics for model diagrams implementing steps 102, according to some embodiments.

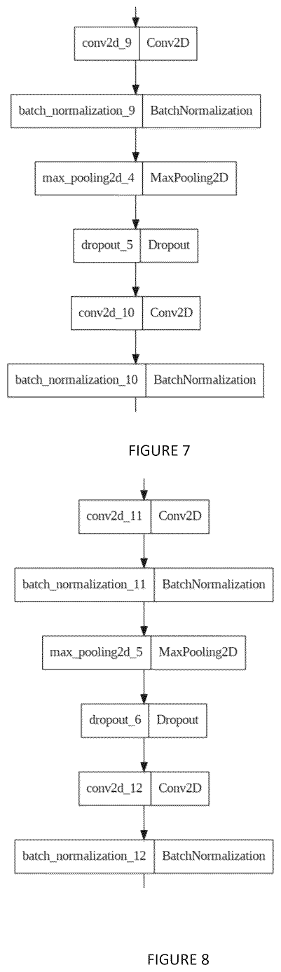

FIG. 11 illustrates an example process 1100 for data preparation and processing for AI Action recognition, according to some embodiments. Process 1100 can be used for data preparation and preprocessing for AI Action Recognition. Process 1100 can use two different approaches for AI Action Recognition. In the first approach, process 1100 can recognize actions. In the second approach process 1100 can use AI to detect landmarks on the person's body and then use mathematical calculations to recognize actions. In step 1102, process 1100 can implement data collection. Process 1100 can implement data filtration in step 1104. Process 1100 can implement Data augmentation 1106. Process 1100 can implement landmark extraction in step 1108. Process 1100 can implement pre-processing operations in step 1110. Process 1100 can implement data splitting operations in step 1112.

Data collection is now discussed. For training and evaluation of the Human Action Recognition Model, process 1100 can use recorded videos of actions with only one subject performing all actions. Process 1100 can use three (3) classes. “Jump,” “Duck” and “No action” In no action we included “Walk,” “Stand,” “Kicks” and some other actions to add noise in the dataset. Then Process 1100 can use extracted frames from these videos.

Data filtration is now discussed. Process 1100 can use ten (10) consecutive frames for every action, and process 1100 can remove unnecessary frames. Data augmentation is now discussed. Process 1100 can augment the dataset by zooming in and out images and then resizing to get different torse sizes to avoid overfitting.

Landmark extraction is now discussed. We extracted 3-dimensional landmarks on the person's body using media pipe API and used 13 out of 33 for model training. The media pipe API can use a Blaze Pose Detector to detect a person and Blaze Pose GHUM 3D to localize 33 landmarks on a person's body.

Pre-processing is now discussed. Process 1100 can use normalized landmarks to range (0-1). Data Splitting is now discussed. The dataset can then be split into training and validation sets with 75:25 ratio respectively.

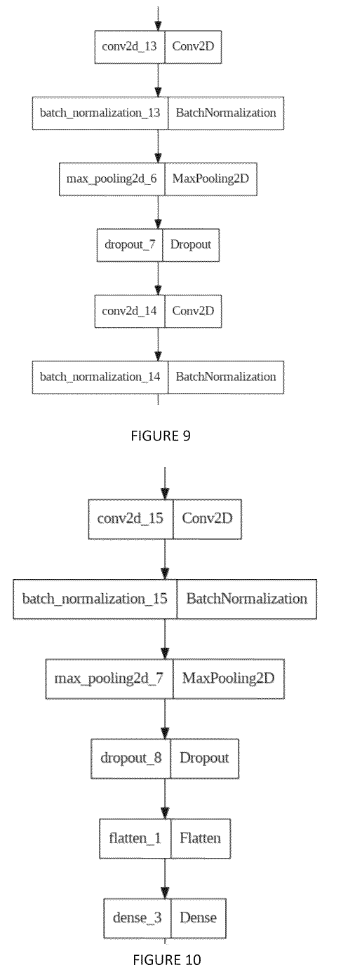

FIG. 12 illustrates an example process for Data Processing for Action Recognition, according to some embodiments.

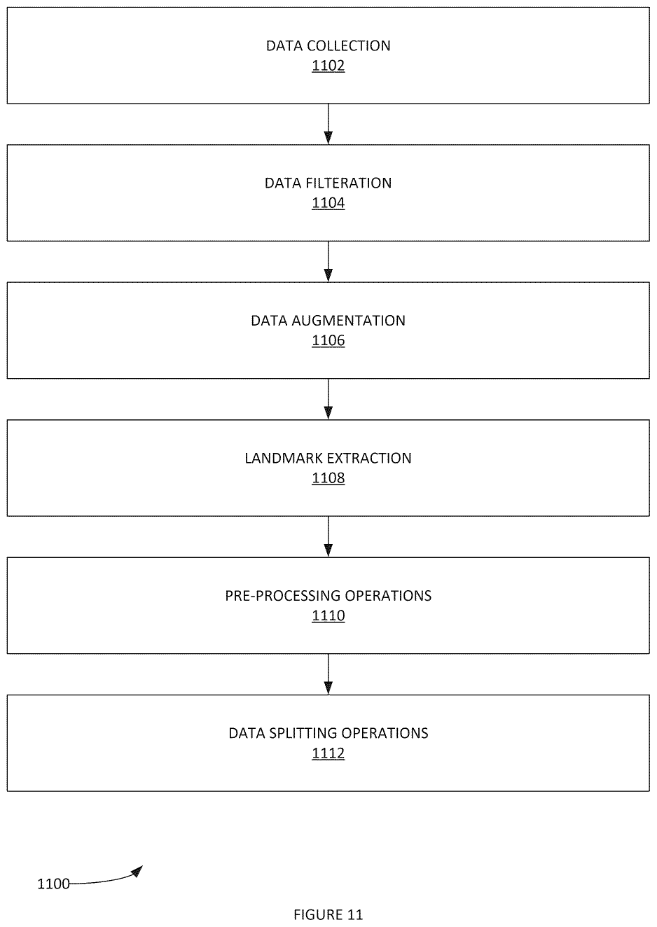

FIG. 13 illustrates an example AI action recognition model 1300, according to some embodiments. AI action recognition model 1300 can include a pass-through layer 1302, a custom build layer non trainable layer 1304, a fully connected layer 1306, a second custom build layer 1308, a LSTM layer 1310, and output layer 1312. AI action recognition model 1300 can include a LSTM-RNN Model architecture.

AI action recognition model 1300 can include various layers. In one example, there can be six layers in the AI action recognition model 1300. The first layer is the input layer also known as the “Pass Through layer” which is only used to define the input shape. Then there is a custom build layer non-trainable layer. This layer may not contain weights to be trained during training. This layer can transpose the input image matrix and then reshapes it to acquire features array with features equal to the number of landmarks (e.g. 13 in one example).

Then AI action recognition model 1300 can have a fully connected layer with neurons equal to the number of neurons. A second custom build layer which is also a non-trainable layer and simply reshapes the input to feed it into the next recurrent layer.

AI action recognition model 1300 can have an LSTM layer. This can be made up of two LSTM cells stacked on top of each other. This layer extracts the temporal information from the input. In one example, the layer analyzes how the coordinates of landmarks are changing over time. Then comes the output layer which has three (3) of no neurons and Soft-Max activation function.

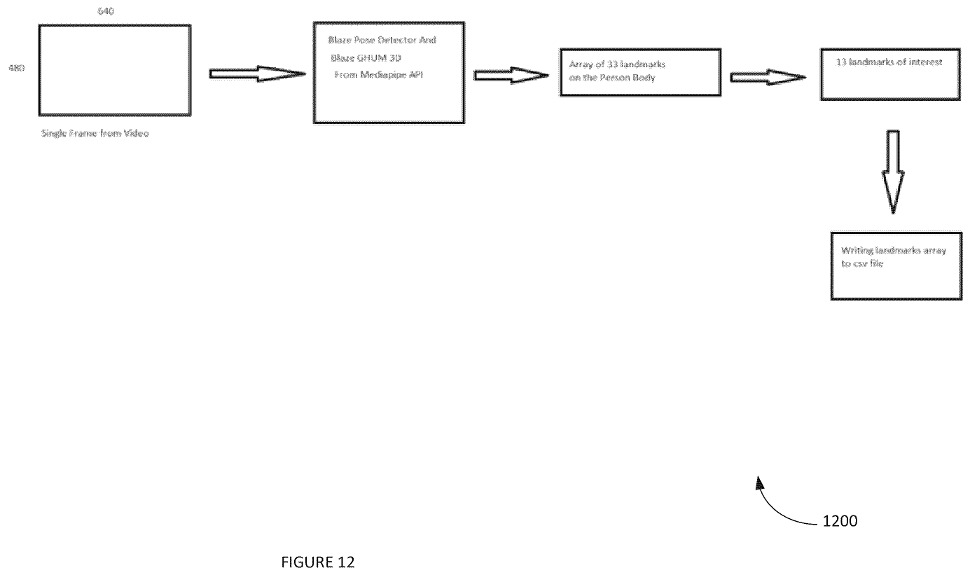

FIG. 14 illustrates an example architecture of an example LSTM Cell 1400, according to some embodiments. LSTM cell 1400 can include a main gate 1402, a forget gate 1404, an input gate 1406, and an output gate 1408. More specifically, LSTM cell 1400 can be an RNN (Recurrent Neural Network) cell. Input of the LSTM cell 1400is the feature array combined with the previous short term hidden state. At the start of the training, since there are no hidden states, this array is initialized with a zero's matrix. As noted, LSTM cell 1400 has four (4) gates. Main Gate 1402 has the usual role of analyzing the current inputs and the previous short term hidden states. The remaining three (3) gates are called gate controllers. Forget gate 1404 controls what information to keep and what information to remove in the long-term state. Input Gate 1406 controls which parts of the current input to add in the long-term state. Output Gate 1408 controls which part of the long-term state should be read and outputs as the current time step.

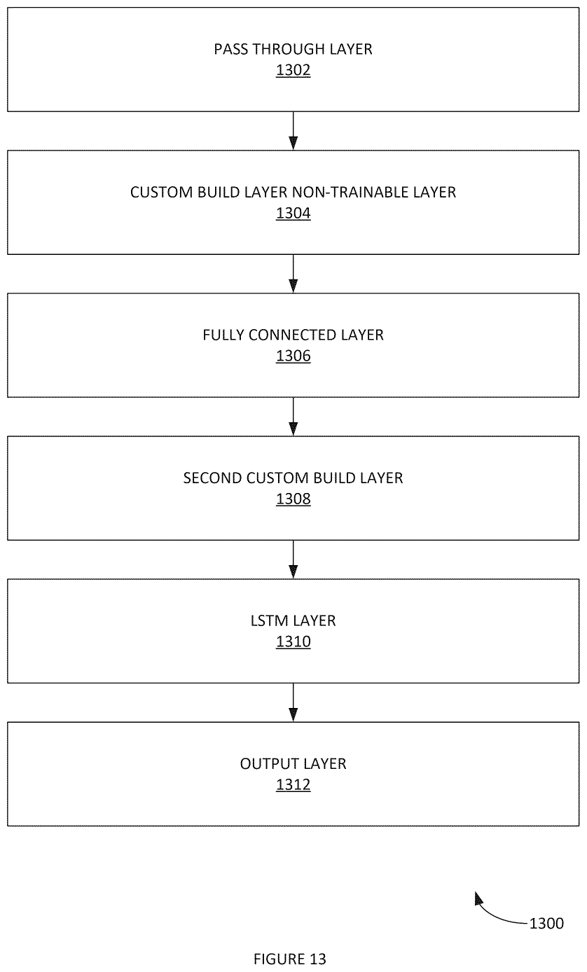

FIG. 15-17 illustrate example model development and/or management operations, according to some embodiments.

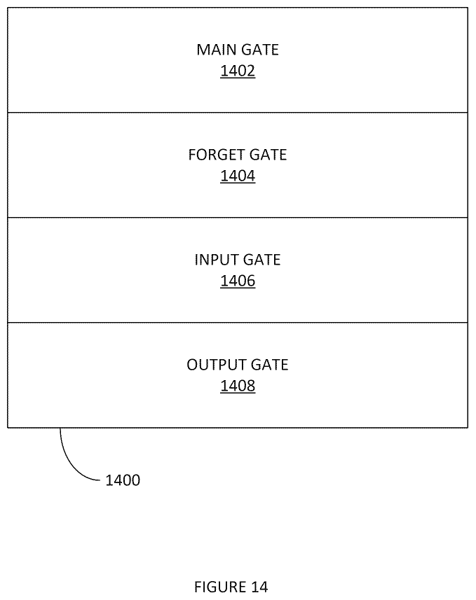

FIG. 18 illustrates an example process 1800, according to some embodiments. Process 1800 can implement data preparation in step 1802. It is noted that in some embodiment, there may be no need to prepare data because process 1800 can use pre-trained landmarks detector from Media pipe API. Process 1800 can implement detection process(es) in step 1804. One frame can be input into the Mediapipe Landmarks Detector, which outputs thirty-three (33) landmarks on a person's body. Only Shoulder joints landmarks, Hip Joints Landmarks and Ankle joints landmarks are selected for further processing. Mathematical calculations and other programming logics are used on these landmarks to classify the action into the following categories. 1) Jump 2) Duck Position 3) Duck 4) Right Tilt 5) Left Tilt 6) No Action; etc.

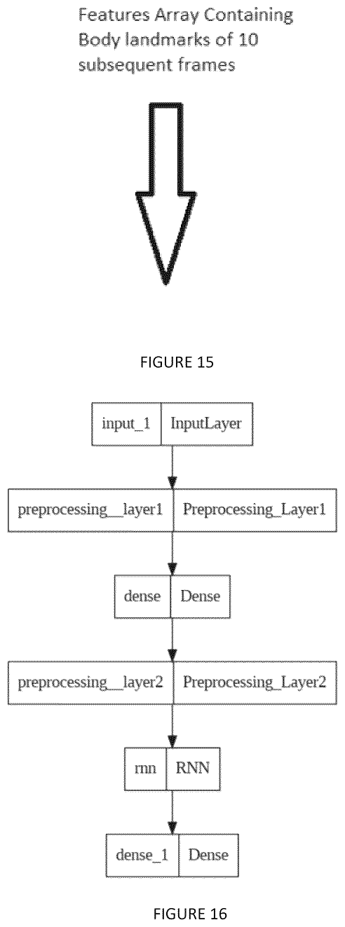

FIG. 19 illustrates an example logic 1900, according to some embodiments. Logic 1900 includes, inter alia: Logic To Detect Right And Left Tilts 1902 Logic To Detect Jump Action 1904 Logic To Detect Duck Position 1906 Logic To Detect Duck Action 1908 Logic To Detect “No Action Action” 910 Logic To Counter The Confusion Of Person moving forward Being Classified As Jumping 1912.

Logic To Detect Right And Left Tilts 1902 is now discussed. A threshold (30 in our case) is chosen to compare it with difference. The difference between the y ordinates of the right shoulder and the left shoulder is calculated. If the difference is greater than the positive threshold, then the action is classified as “Right Tilt”. If the difference is less than the negative of threshold, then the person is tilting to the left.

Logic To Detect Jump Action 1904 is now discussed. Ten (10) consecutive Y ordinates of right left shoulders and ankles are saved and put into a list. This list keeps updating along with the input frames. With every new distance being added to the list, an element in the first position is being discarded from the list. So the length of the list remains equal to 10 throughout the program run.

Differences between the first and last elements of the lists are calculated. Again a threshold (10 in our case) is chosen for comparison. If all the differences are greater than the threshold, then the action is classified as “Jump.”

Logic To Detect Duck Position 1906 is now discussed. The distances between the two shoulder points, right hip joint and right ankle, and left hip joint and left ankle are calculated using the distance formula. Let these distances be dist_1, dist_2 and dist_3 respectively. Then two ratios namely right_ratio and left_ratio are calculated by dividing dist_1 by dist_2 and then by dist_3. If both right and left ratios are greater than or equal to a chosen threshold (0.55 in our case) then the action is “Duck Position”.

Logic To Detect Duck Action 1908 is now discussed. The ratio threshold for duck position is increased a little bit more (e.g. the number can vary depending on the extent to which the person should bow to perform the duck action, we can set this number as per our requirement). Then instead of duck position the action could be counted as duck action.

Logic To Detect “No Action” 1910 is now discussed. If none of the above-mentioned actions are detected, then the action by default belongs to the “No Action” class.

Logic To Counter The Confusion Of Person moving forward Being Classified As Jumping 1912 is now discussed. If the person is moving forward, the Logic that we used for detecting the Jump Action could be broken. Means this action can be mistook as “jump”. To counter this issue we wrote the logic to detect this forward moving action separately.

A list of ten (10) consecutive distances between the right and left shoulders (calculated using distance formula) is created. The updated process for the list is the same as before. The difference between the last and first elements of this list is then calculated. If the difference is greater than the threshold (10—our case), then the person is moving forward instead of jumping. This action is counted as ‘No Action”.

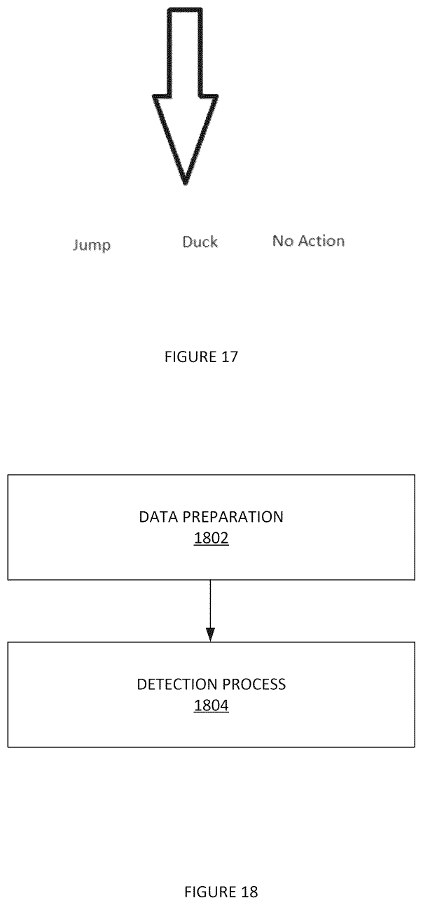

FIG. 20 illustrates an example process of a full action recognition pipeline for approach 2, according to some embodiments.

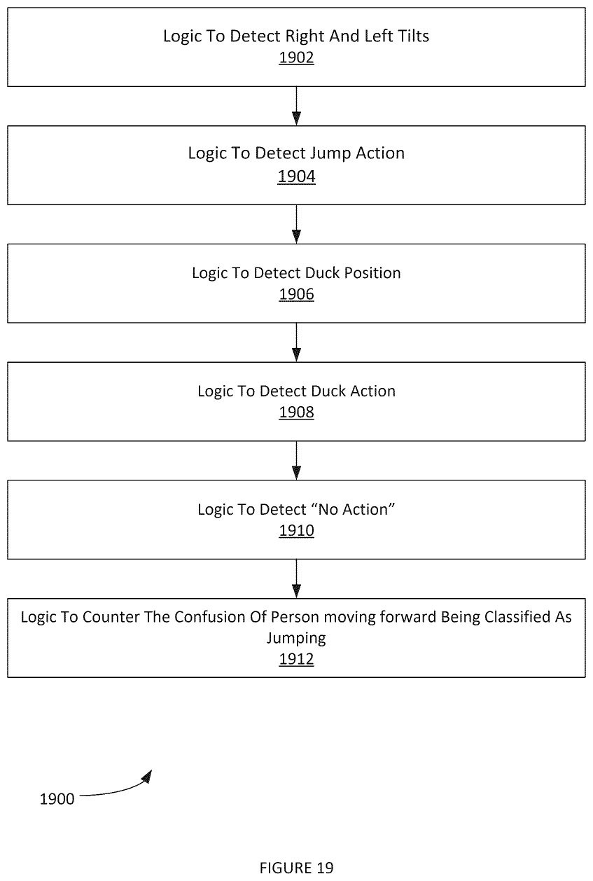

FIG. 21 illustrates an example process 2100 for implementing an SDK, according to some embodiments.

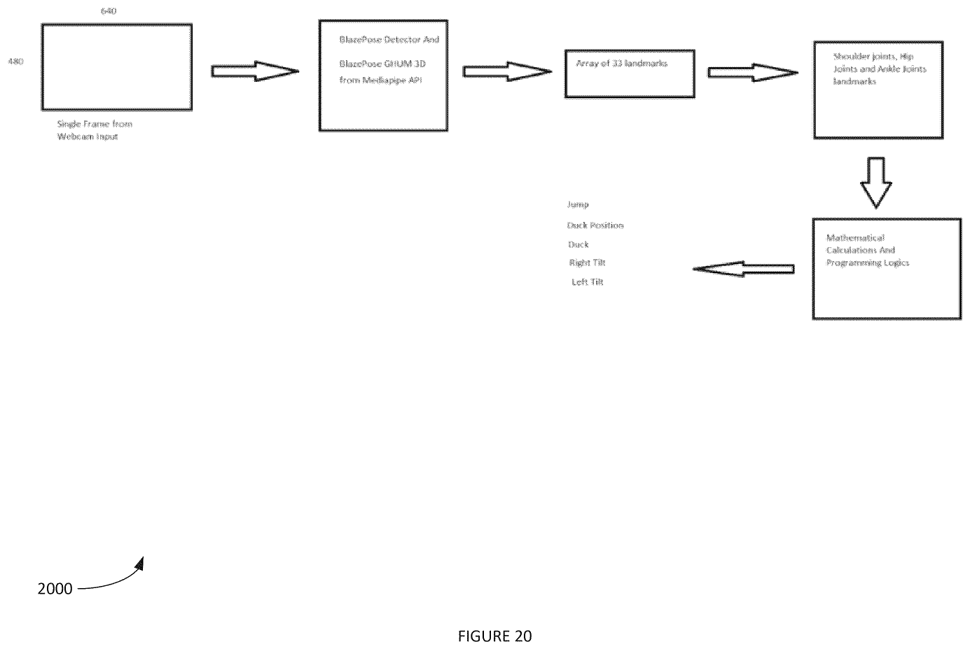

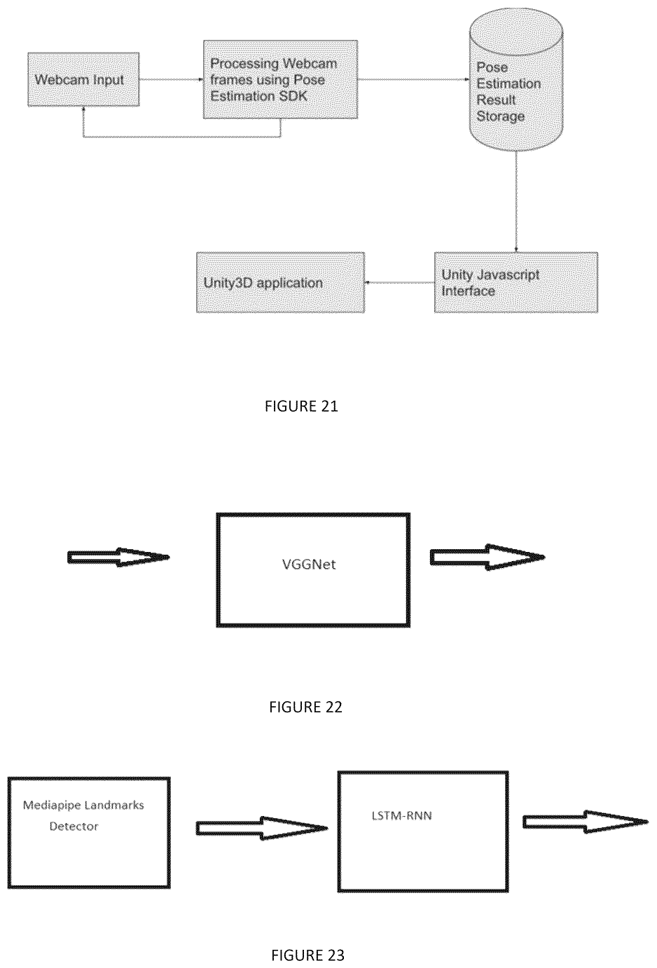

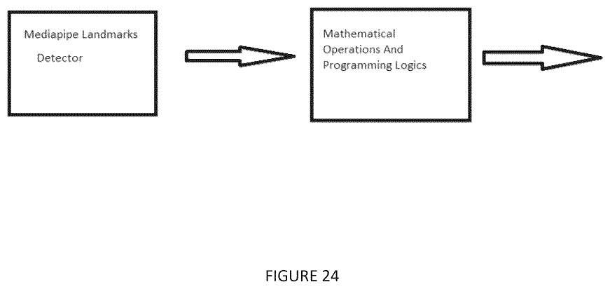

It is noted that the second box of process 2100 can be removed and FIGS. 22-24 can be included therein. FIG. 22 can be used for emotion recognition. FIG. 23 can be used for Action Recognition Approach 1. FIG. 24 can be used for Action Recognition Approach 2.

In one example, a pose estimation SDK obtains a Webcam frame as input. The Pose Estimation SDK can estimate the pose of a person or an object in a video stream, usually from a Webcam or a video file. This takes a single frame from the Webcam as an input for each estimation. The frames are passed into the Pose SDK model as a binary input array. The Webcam frame is passed into the Pose SDK model as a binary input array. The binary input array is a representation of the image data in a compressed format that can be easily processed by the SDK. The Pose SDK model uses deep learning techniques to analyze the input array and estimate the pose of the person or object in the frame.

The results of pose estimations are stored in memory as a global variable. Once the Pose SDK model has estimated the pose of the person or object in the frame, the results are stored in memory as a global variable. This allows the results to be accessed and used by other parts of the application, such as the game engine.

Using the JavaScript Web request Animation API, the SDK continues to extract frames, estimate poses, and store the results into memory. To continuously estimate the poses in the video stream, the Pose Estimation SDK uses the Web request Animation API to extract frames from the Webcam and estimate the poses in real-time. As each new frame is processed, the SDK stores the results into memory, overwriting the previous results.

In Unity, the .jslib APIs extract the results from memory one by one and parse them into C# managed classes of Keypoints, where the key points are used to handle the game experience. Once the Pose Estimation SDK has estimated the poses and stored the results into memory, the Unity game engine can access and use these results by calling the .jslib APIs. These APIs extract the results from memory one by one and parse them into C# managed classes of Keypoints, which represent the positions and orientations of the body parts of the person or object in the video stream. These Keypoints can then be used to handle the game experience, such as animating characters or controlling game mechanics.

### Additional Example Computing Systems

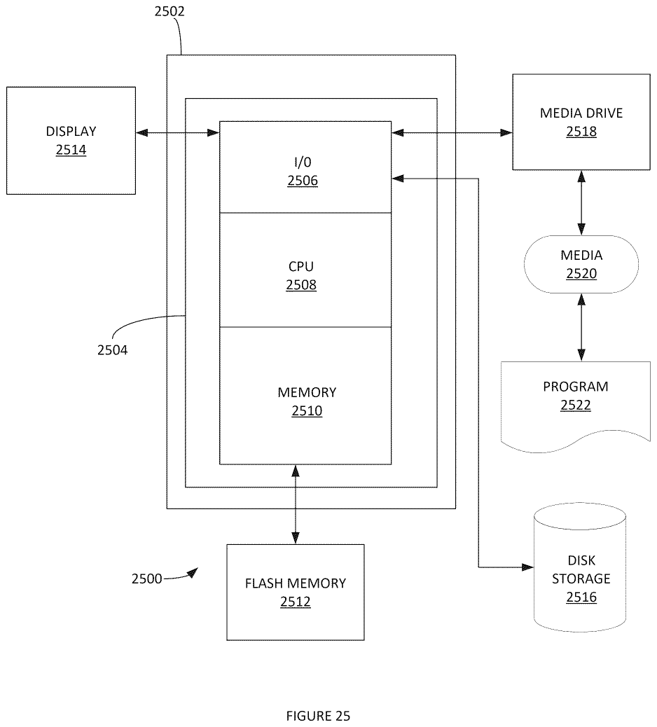

FIG. 25 depicts an exemplary computing system 2500 that can be configured to perform any one of the processes provided herein. In this context, computing system 2500 may include, for example, a processor, memory, storage, and I/O devices (e.g., monitor, keyboard, disk drive, Internet connection, etc.). However, computing system 2500 may include circuitry or other specialized hardware for carrying out some or all aspects of the processes. In some operational settings, computing system 2500 may be configured as a system that includes one or more units, each of which is configured to carry out some aspects of the processes either in software, hardware, or some combination thereof.

FIG. 25 depicts computing system 2500 with a number of components that may be used to perform any of the processes described herein. The main system 2502 includes a motherboard 2504 having an I/O section 2506, one or more central processing units (CPU) 2508, and a memory section 2510, which may have a flash memory card 2512 related to it. The I/O section 2506 can be connected to a display 2514, a keyboard and/or other user input (not shown), a disk storage unit 2516, and a media drive unit 2518. The media drive unit 2518 can read/write a computer-readable medium 2520, which can contain programs 2522 and/or data. Computing system 2500 can include a web browser. Moreover, it is noted that computing system 2500 can be configured to include additional systems in order to fulfill various functionalities. In another example, computing system 2500 can be configured as a mobile device and include such systems as may be typically included in a mobile device such as GPS systems, gyroscope, accelerometers, cameras, etc.

### Additional Machine Learning Implementations

Machine learning/optimization systems can be utilized herein. Machine learning/optimization systems can use various ML processes to generate models that automate and/or optimize the various steps and systems provided herein. Machine learning process(es) can manage and implement the various machine learning operations discussed herein. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct a decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naive Bayes classifier) is trained on the training dataset using a supervised learning method. In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fitted on the training dataset after every epoch (e.g. one round of training). Now, based on the performance of the model on this unseen data (e.g. validation set), the optimization algorithm tweaks the model weights to improve the model's generalization.

Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. In cross-validation, the held-out set is called validation set.

This material can be used to supplement/replace various AI/ML operations discussed herein.

### Emotion and Action Recognition Ai System

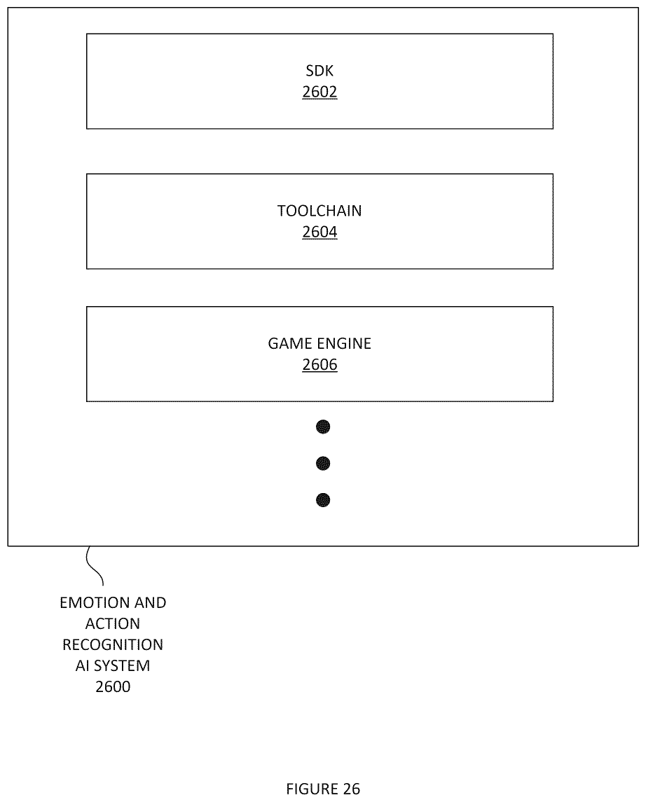

FIG. 26 illustrates an example Emotion and Action Recognition AI System 2600, according to some embodiments. An Emotion and Action Recognition AI System 2600 is now discussed. The Emotion and Action Recognition AI System 2600 provides a sophisticated computer vision system designed for simultaneous emotion and action recognition in real-time video streams. Emotion and Action Recognition AI System 2600 addresses traditional limitations in facial expression analysis and pose estimation by integrating these capabilities into a unified framework.

Emotion and Action Recognition AI System 2600 consists of a Software Development Kit (SDK) 2602 that processes image data using a convolutional neural network for facial expression identification and a landmark detection model for body movement analysis. The SDK 2602 supports classification of five emotional states (e.g. angry, happy, sad, neutral, and surprise) and employs a Long Short-Term Memory (LSTM) network to analyze action sequences across multiple frames.

For optimal performance, the SDK 2602 implements frame buffering, efficient memory management, batch normalization, and data augmentation techniques. SDK 2602 also utilizes dropout layers to mitigate overfitting and employs multi-threaded processing to handle concurrent tasks efficiently.

The architecture provides cross-platform compatibility, with specific build options for Windows and WebGL environments. For Windows deployments, developers can choose between the custom SDK or Google's Blaze Pose SDK based on their specific performance requirements. WebGL support is enabled through a Toolchain 2604 (e.g. Emscripten, etc.) which compiles C++/C# code into WebAssembly for browser-based deployments.

In some examples, Toolchain 2604 can be a source-to-source compiler and/or transpiler that is designed to compile C and C++ code into WebAssembly or JavaScript, enabling high-performance web applications. By translating low-level languages into web-compatible formats, Toolchain 2604 allows developers to run code originally written for desktop or native environments directly in web browsers with near-native performance.

Toolchain 2604 can be a set of programming tools that work together in a sequence to translate, compile, and process code from one state to another. For example, when the document describes Emscripten as a “toolchain that compiles C++/C# code into WebAssembly,” it can refer to Emscripten's role as an integrated collection of software tools that handle the entire process of transforming native code (e.g. written in C++ or C#) into WebAssembly format that can run in web browsers. Toolchain 2604 can includes multiple components working together: compilers that translate the source code Linkers that combine compiled code with necessary libraries; optimizers that improve performance and reduce size Packaging tools that prepare the final output for web deployment. The purpose of this toolchain in the patent's context is to enable the emotion and action recognition SDK, originally written in C++ or C#, to function effectively in web browsers through WebGL without requiring a complete rewrite of the code in JavaScript. This transformation process can be a part of the cross-platform strategy described in the patent, allowing the same core technology to operate across both desktop and web environments.

Game engine 2606 integration is achieved through a custom C# wrapper that leverages a toolchain's 2604 (e.g. Emscripten) interoperability to directly call JavaScript functions without requiring WebSocket communication. This approach minimizes latency and ensures efficient data flow from the pose estimation system to Game engine 2606 (e.g. Unity, etc.) skeletal rig. As used herein, Game engine 2606 can be a Unity Game Engine. Game engine 2606 can be a platform for developing interactive 2D and 3D content, particularly games. In the context of the patent application, Game engine 2606 can be a target environment where the emotion and action recognition capabilities are being implemented.

The modular design of Emotion and Action Recognition AI System 2600 facilitates adaptation to various game engines beyond Game engine 2606, using various modifications to input and output layers while preserving the core recognition logic. This flexibility extends to third-party asset integration and potential support for virtual reality (VR) and/or augmented reality (AR) platforms.

The technology Game engine 2606 has applications across multiple domains including interactive gaming, healthcare monitoring, fitness tracking, and remote learning environments, making it a versatile solution for developers seeking real-time emotion and action recognition capabilities.

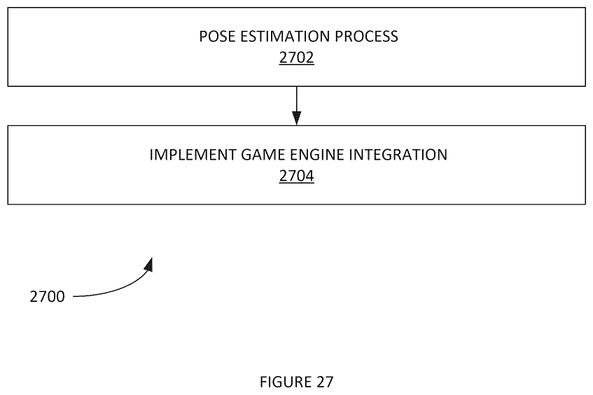

FIG. 27 illustrates an example process 2700 for emotion and action recognition with AI, according to some embodiments. In step 2702, process 2700 implement pose estimation. For example, in WebGL mode, the SDK 2602 operates by:
Capturing video frames from a webcam or video file;
Converting each frame into a binary input array; and
Using deep learning techniques to estimate poses and classify emotions and actions.

The results of pose estimations are stored in memory as global variables and accessed by JavaScript APIs for further processing. For Unity-based deployments, .jslib APIs are used to extract and parse these results into C# managed classes of keypoints. These keypoints are then utilized to enhance user experiences, such as animating characters or controlling game mechanics.

To improve accuracy and reduce latency, the SDK leverages optimization techniques such as batch normalization and data augmentation during preprocessing. By rotating, shifting, and scaling images, the SDK ensures robust performance in diverse lighting and environmental conditions. The SDK also employs dropout layers to mitigate overfitting and improve model generalization.

Additionally, the SDK supports multi-threaded processing to handle simultaneous pose estimation and emotion recognition tasks efficiently. By partitioning tasks across multiple threads, the SDK minimizes processing bottlenecks and ensures smooth real-time performance.

In step 2704, process 2700 can implement game engine integration. for example, process 2700 can implement integration with Unity using C# Wrapper. In this example, process 2700 integrates BlazePose JS into Unity using a custom-built C# wrapper. Instead of using WebSockets for communication, this process leverages Emscripten C# (e.g. as Toolchain 2604, etc.) interoperability to directly call JavaScript functions from within Unity. The integration process involves three key components working in sequence. First, a C# wrapper acts as a bridge between Unity and BlazePose JS, using JavaScript function calls to fetch real-time pose estimation data. Second, Emscripten (e.g. as a part of Toolchain 2604) enables Unity (and/or another game engine) to execute BlazePose JavaScript functions without requiring server-client communication, ensuring faster data flow and minimal latency compared to alternative approaches. Third, the pose estimation data (e.g. using key points) is directly sent to Unity's skeletal rig to map real-time poses, allowing for seamless animation control within the Unity environment.

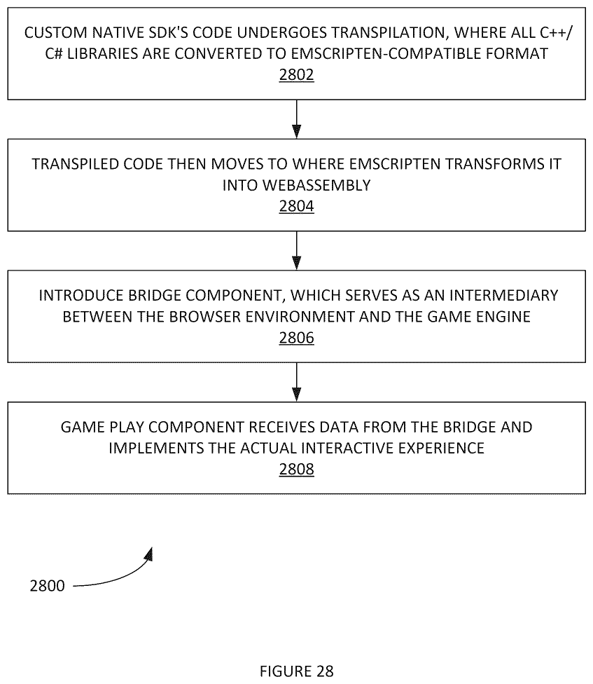

FIG. 28 illustrates an example process 2800 for implementing a WebGL Deployment Process Flow for Emotion and Action Recognition SDK, according to some embodiments. The WebGL deployment process for the emotion and action recognition SDK involves a systematic flow of operations across multiple components. The process begins with the Custom Native SDK, which contains the core functionality for emotion and action recognition. This SDK is written in C++/C# and provides the foundational capabilities for video processing.

In step 2802, the Custom Native SDK's code undergoes transpilation, where all C++/C# libraries are converted to Emscripten-compatible format. This conversion prepares the native code for web browser execution. The transpiled code then moves to step 2804, where Emscripten transforms it into WebAssembly. This transformation is crucial as it converts the code into a binary instruction format that can be executed efficiently in web browsers.

In step 2806, process 1800 introduces the Bridge component, which serves as an intermediary between the browser environment and the game engine. This Bridge facilitates communication between the WebAssembly code running in the browser and the game engine's runtime environment. The Bridge component utilizes JavaScript APIs to access the pose estimation results that are stored in memory as global variables.

In step 2808, the Game Play component receives data from the Bridge and implements the actual interactive experience. For Unity-based deployments, .jslib APIs extract and parse the pose estimation results into C# managed classes of key points. These key points enable dynamic character animation and game mechanics based on real-time user movements and emotional states.

Throughout the execution phase, the Game Play component maintains continuous communication with the Bridge for real-time tracking of user emotions and actions. This ongoing communication loop ensures that the application remains responsive to changes in user expressions and movements. The SDK enhances performance through optimization techniques including batch normalization, data augmentation, dropout layers, and multi-threaded processing, which collectively contribute to robust performance across diverse environmental conditions.

This architecture ensures seamless and efficient emotion and action recognition within browser environments, making the SDK suitable for a wide range of applications from interactive gaming to healthcare monitoring.

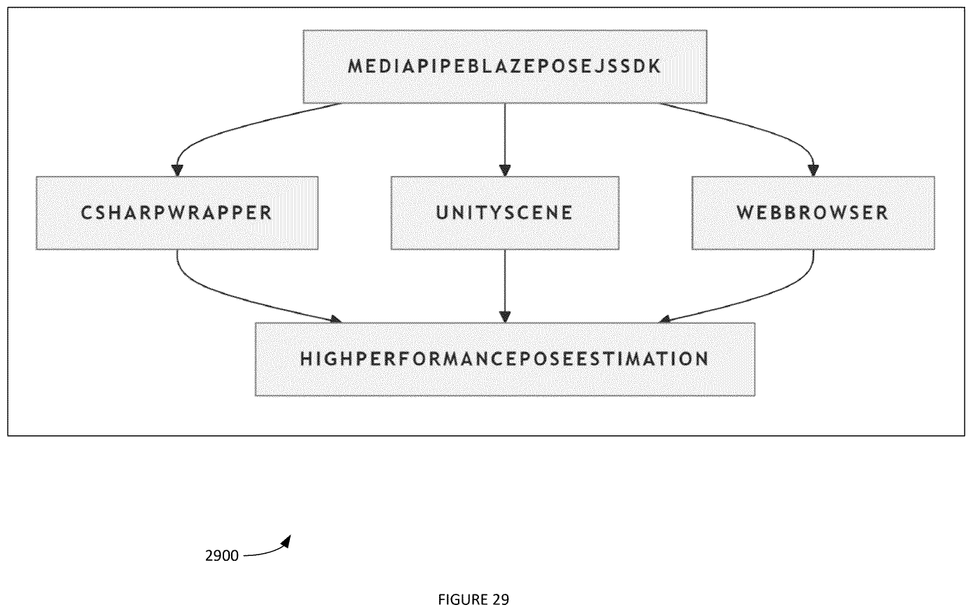

FIG. 29 illustrates an example visualization of an integration process 2900, according to some embodiments. integrates BlazePose JS into a gaming engine (e.g. Unity, etc.) using a custom-built C# wrapper by way of example. Instead of using WebSockets for communication, this process leverages Emscripten C# interoperability to directly call JavaScript functions from within Unity. As used herein by way of example, BlazePose JS is a JavaScript implementation of Google's MediaPipe BlazePose, a machine learning model designed for real-time human pose estimation that detects key body landmarks from video input. It tracks body movements by identifying up to thirty-three (33) body landmarks, enabling applications to recognize human postures and actions with minimal computational resources. It is noted that other pose-estimation libraries or human-pose tracking frameworks can be utilized in lieu of BlazePose JS.

The visualization of the integration process 2900 involves three key components working in sequence. First, a C# wrapper acts as a bridge between Unity and BlazePose JS, using JavaScript function calls to fetch real-time pose estimation data. Second, Emscripten enables Unity to execute BlazePose JavaScript functions without requiring server-client communication, ensuring faster data flow and minimal latency compared to alternative approaches. Third, the pose estimation data (e.g. using key points) is directly sent to Unity's skeletal rig to map real-time poses, allowing for seamless animation control within the Unity environment.

In some embodiments, this enhanced SDK provides robust emotion and action recognition functionality across Windows and WebGL platforms. Its adaptability to multiple game engines and support for Blaze Pose integration ensures flexibility, while Emscripten enables seamless web-based deployments. These improvements position the SDK as a versatile and future-ready solution for a wide range of applications in gaming, security, healthcare, and human-computer interaction.

With advanced configurability and high performance, the SDK is designed to meet the demands of modern applications that require real-time analysis and responsiveness. Its modular design ensures future-proofing, making it easy to implement new recognition models or expand to emerging platforms as technology evolves.

By leveraging cutting-edge deep learning techniques and optimization strategies, the SDK delivers high accuracy and low latency, making it an ideal choice for developers seeking a scalable and efficient emotion and action recognition solution.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A method for emotion and action recognition, comprising: receiving, at one or more processors, image data from a video stream; analyzing, using a convolutional neural network, the image data to identify facial expressions for emotion recognition; extracting, using a landmark detection model, a plurality of body landmarks from the image data; determining, based on the plurality of body landmarks, spatial relationships between body joints over a sequence of frames;
classifying, using a long short-term memory (LSTM) network, an action based on changes in the spatial relationships across the sequence of frames; and outputting both an emotional state classification and an action classification based on the analyzing and the classifying.

2. The method of claim 1, wherein analyzing the image data comprises:
rescaling pixel intensities of the image data to a range between 0 and 1;
processing the rescaled image data through a plurality of convolutional blocks;
and wherein each convolutional block comprises a two-dimensional convolutional layer, a batch normalization layer, and a max pooling layer.

3. The method of claim 1, wherein extracting the plurality of body landmarks comprises: detecting, using a pose detector, thirty-three landmarks on a person's body; and selecting thirteen landmarks from the thirty-three landmarks for action recognition.

4. The method of claim 1, wherein determining the spatial relationships comprises: calculating distances between shoulder points, hip joints, and ankle joints from the plurality of body landmarks; and storing ten consecutive sets of the calculated distances in a temporal buffer.

5. The method of claim 4, further comprising: detecting a jump action when differences between first and last elements in the temporal buffer exceed a first threshold value; and detecting a duck action when ratios between shoulder points and lower body joints exceed a second threshold value.

6. The method of claim 1, wherein analyzing the image data for emotion recognition comprises: classifying the facial expressions into one of five emotional states comprising angry, happy, sad, neutral, and surprise.

7. The method of claim 1, wherein the convolutional neural network comprises: four convolutional blocks; a flatten layer; three dense layers; and wherein a final dense layer implements a SoftMax activation function.

8. The method of claim 1, wherein the LSTM network comprises: a custom build non-trainable layer for landmark feature extraction; two stacked LSTM cells; and an output layer implementing a SoftMax activation function.

9. The method of claim 1, further comprising: implementing data augmentation on training data by applying at least one of brightness adjustment, rotation, shifting, flipping, shearing, or zooming.

10. The method of claim 1, further comprising: detecting forward motion by: calculating distances between right and left shoulder landmarks over ten consecutive frames; determining differences between first and last distance values; and classifying forward motion when the differences exceed a threshold value.

11. A system for emotion and action recognition, comprising: one or more processors; a memory coupled to the one or more processors; an image capture device configured to provide image data; a convolutional neural network implemented by the one or more processors and configured to analyze facial expressions in the image data; a landmark detection model implemented by the one or more processors and configured to extract body landmarks from the image data; a long short-term memory (LSTM) network implemented by the one or more processors and configured to classify actions based on the body landmarks; and wherein the one or more processors are configured to output both emotional state classifications and action classifications based on the analyzed facial expressions and classified actions.

12. The system of claim 11, wherein the convolutional neural network comprises: a rescaling layer configured to normalize pixel intensities to a range between 0 and 1; a plurality of convolutional blocks; and wherein each convolutional block of the plurality of convolutional blocks comprises a two-dimensional convolutional layer, a batch normalization layer, and a max pooling layer.

13. The system of claim 12, wherein the landmark detection model comprises: a pose detector configured to detect thirty-three landmarks on a person's body; and a landmark selector configured to select thirteen landmarks from the thirty-three landmarks for action recognition.

14. An emotion and action recognition system comprising: a computer vision module configured to receive image data from video streams; a neural network configured to identify facial expressions from the received image data; a landmark detection model configured to extract body landmarks for action classification from the received image data; a memory storing instructions; and a processor configured to execute the instructions to: capture video frames from at least one of a camera or a video file, convert each frame into a binary input array, apply deep learning techniques to estimate poses and classify emotions into at least five emotional states, process a sequence of frames using a recurrent neural network to output classified actions based on changes in spatial relationships, store results of pose estimations as global variables in the memory, access the stored results using application programming interfaces for further processing, and implement optimization techniques including at least batch normalization and data augmentation during preprocessing to improve accuracy and reduce latency.

15. The system of claim 14, wherein the processor is further configured to execute the instructions to: employ a code conversion toolchain to compile native code into web browser compatible format to enable execution in web environments; and implement a bridging component configured to facilitate communication between web browser code and a game engine runtime environment.

16. The system of claim 15, wherein the at least five emotional states comprise angry, happy, sad, neutral, and surprise.

17. The system of claim 16, wherein the processor is further configured to execute the instructions to implement multi-threaded processing to handle simultaneous pose estimation and emotion recognition tasks by partitioning tasks across multiple processing threads.

18. The system of claim 17, wherein the processor is further configured to execute the instructions to: implement a software wrapper configured to bridge communication between a game engine and a pose estimation library; and enable direct function calls between the game engine and the pose estimation library without requiring server-client communication.

19. The system of claim 18, wherein the processor is further configured to execute the instructions to: maintain continuous communication between the game engine and the bridging component for real-time tracking of user emotions and actions; and extract and parse pose estimation results into managed classes of key points for use in enhancing user experiences through character animation or game control mechanisms.
